(19) United States
(12) Patent Application Publication
(10) Pub. No.: US 2017/0314586 A1
(43) Pub. Date: Nov. 2, 2017

(54) CONTROL SYSTEM OF HYBRID CONSTRUCTION MACHINE

(71) Applicant: KYB Corporation, Tokyo (JP)

(72) Inventors: Masahiro EGAWA, Saitama (JP); Haruhiko KAWASAKI, Kanagawa (JP); Yasuhiro YONEHARA, Kanagawa (JP); Masayuki KOBAYASHI, Tokyo (JP)

(73) Assignee: KYB Corporation, Tokyo (JP)

(21) Appl. No.: 15/524,067

(22) PCT Filed: Nov. 19, 2015
(86) PCT No.: PCT/JP2015/082603

§ 371 Date: May 3, 2017

(30) Foreign Application Priority Data
Dec. 5, 2014 (JP) 2014-246911

(51) Int. Cl. F15B 21/14; E02F 9/22; H02J 7/14

(52) U.S. Cl. CPC F15B 21/14; H02J 7/14; E02F 9/2225; E02F 9/2267; E02F 9/2292

(57) ABSTRACT

A control system of a hybrid construction machine includes fluid pressure pumps configured to supply a working fluid to a fluid pressure actuator, a regeneration unit having a regeneration motor for regeneration to be rotated by the working fluid discharged from a load side pressure chamber of the fluid pressure actuator, a rotating electric motor coupled to the regeneration motor, and a storage battery configured to store electric power generated by the rotating electric motor, and a variable throttle configured to bleed a portion of the working fluid obtained by excluding a flow rate of the working fluid guided to the regeneration motor from the working fluid discharged from the load side pressure chamber.

### TECHNICAL FIELD

The present invention relates to a control system of a hybrid construction machine.

### BACKGROUND ART

Conventionally, there is a known hybrid construction machine that performs energy regeneration by rotating a hydraulic motor by utilizing working oil guided from an actuator.

JP2011-241539A discloses a hybrid construction machine in which in a case where a temperature of a battery is a threshold value of a low temperature region or lower or a threshold value of a high temperature region or higher, a hydraulic regeneration amount to be guided from a piston side chamber of a boom cylinder to a hydraulic motor is reduced.

### SUMMARY OF INVENTION

However, in the hybrid construction machine described in JP2011-241539A, there is a fear that in a case where the hydraulic regeneration amount is reduced, a flow rate of working oil discharged from the piston side chamber of the boom cylinder is reduced and working speed of the boom cylinder is changed.

An object of the present invention is to provide a control system of a hybrid construction machine capable of suppressing a change in working speed of an actuator even in a case where a regeneration flow rate is controlled and changed.

According to one aspect of the present invention, a control system of a hybrid construction machine includes a fluid pressure pump configured to supply a working fluid to a fluid pressure actuator, a regeneration unit having a regeneration motor for regeneration to be rotated by the working fluid discharged from a load side pressure chamber of the fluid pressure actuator, a rotating electric motor coupled to the regeneration motor, and a storage battery configured to store electric power generated by the rotating electric motor, and a variable throttle configured to bleed a portion of the working fluid obtained by excluding a flow rate of the working fluid guided to the regeneration motor from the working fluid discharged from the load side pressure chamber.

### BRIEF DESCRIPTION OF DRAWINGS

FIG. 1 is a circuit diagram showing a control system of a hybrid construction machine according to a first embodiment of the present invention.

FIG. 2 is a diagram showing an example of a map of a battery temperature coefficient with respect to a temperature of a battery.

FIG. 3 is a diagram showing an example of a map of a charge coefficient with respect to a SOC of the battery.

FIG. 4 is a circuit diagram showing a control system of a hybrid construction machine according to a second embodiment of the present invention.

### DESCRIPTION OF EMBODIMENTS

Hereinafter, embodiments of the present invention will be described with reference to the drawings.

### First Embodiment

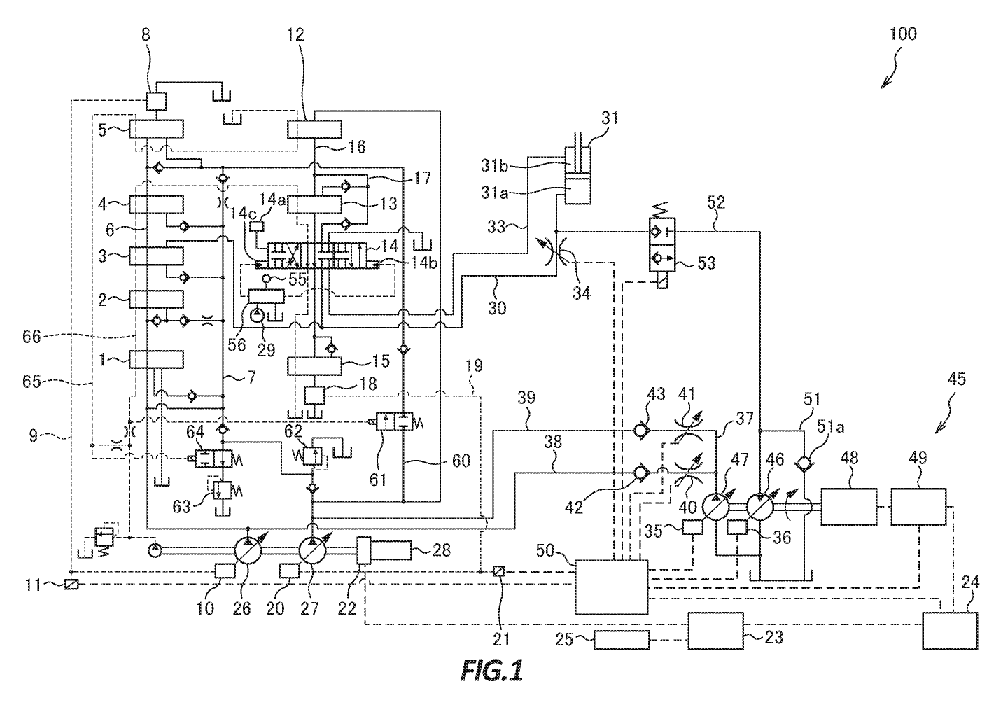

Hereinafter, with reference to FIGS. 1 to 3, a control system 100 of a hybrid construction machine according to a first embodiment of the present invention will be described. In the following embodiments, a case where the hybrid construction machine is a hydraulic excavator will be described. In the hydraulic excavator, working oil is used as a working fluid.

As shown in FIG. 1, the hydraulic excavator includes first and second main pumps 26 and 27 serving as fluid pressure pumps. Each of the first and second main pumps 26 and 27 is a variable capacity type pump in which a tilting angle of a swash plate can be adjusted. The first and second main pumps 26 and 27 are driven by an engine 28 and coaxially rotated.

The working oil discharged from the first main pump 26 is supplied to an operation valve 1 configured to control a turning motor (not shown), an operation valve 2 for arm first gear configured to control an arm cylinder (not shown), an operation valve 3 for boom second gear configured to control a boom cylinder (not shown), an operation valve 4 configured to control auxiliary attachment (not shown), and an operation valve 5 configured to control a left-hand side first traveling motor (not shown) in order from the upstream side. The turning motor, the arm cylinder, the boom cylinder, and a hydraulic device connected to the auxiliary attachment, and the first traveling motor correspond to fluid pressure actuators (hereinafter, simply referred to as the “actuators”).

The operation valves 1 to 5 control flow rates of the working oil guided from the first main pump 26 to the actuators and control actions of the actuators. The operation valves 1 to 5 are operated by pilot pressure supplied in accordance with an operator of the hydraulic excavator manually operating an operation lever.

The operation valves 1 to 5 are connected to the first main pump 26 through a neutral passage 6 and a parallel passage 7 serving as main passages parallel to each other. On the downstream side of the operation valve 5 in the neutral passage 6, a pilot pressure generation mechanism 8 for generating the pilot pressure is provided. The pilot pressure generation mechanism 8 generates high pilot pressure on the upstream side when a flow rate of the passing working oil is high, and generates low pilot pressure on the upstream side when the flow rate of the passing working oil is low.

In a case where all the operation valves 1 to 5 are placed at neutral positions or in the vicinity of the neutral positions, the neutral passage 6 guides all or part of the working oil discharged from the first main pump 26 to a tank. In this case, since the flow rate of the working oil passing through the pilot pressure generation mechanism 8 is increased, high pilot pressure is generated.

Meanwhile, when the operation valves 1 to 5 are switched to full stroke, the neutral passage 6 is closed and no working oil is distributed. In this case, the flow rate of the working oil passing through the pilot pressure generation mechanism 8 is almost eliminated, and the pilot pressure is maintained to be zero. However, depending on operation amounts of the operation valves 1 to 5, part of the working oil discharged from the first main pump 26 is guided to the actuators, and the remaining working oil is guided to the tank from the neutral passage 6. Therefore, the pilot pressure generation mechanism 8 generates the pilot pressure according to the flow rate of the working oil of the neutral passage 6. That is, the pilot pressure generation mechanism 8 generates the pilot pressure according to the operation amounts of the operation valves 1 to 5.

A pilot passage 9 is connected to the pilot pressure generation mechanism 8. The pilot pressure generated in the pilot pressure generation mechanism 8 is guided to the pilot passage 9. The pilot passage 9 is connected to a regulator 10 configured to control a discharge capacity (tilting angle of the swash plate) of the first main pump 26.

The regulator 10 controls the tilting angle of the swash plate of the first main pump 26 in proportion to the pilot pressure of the pilot passage 9 (a proportional constant takes a negative number). Thereby, the regulator 10 controls a pushing amount per one rotation of the first main pump 26. Therefore, when the operation valves 1 to 5 are switched to full stroke, a flow of the neutral passage 6 is eliminated, and the pilot pressure of the pilot passage 9 becomes zero, which makes the tilting angle of the first main pump 26 maximized. At this time, the pushing amount per one rotation of the first main pump 26 is maximized.

A first pressure sensor 11 configured to detect the pressure of the pilot passage 9 is provided in the pilot passage 9. A pressure signal detected by the first pressure sensor 11 is outputted to a controller 50 to be described later.

The working oil discharged from the second main pump 27 is supplied to an operation valve 12 configured to control a right-hand side second traveling motor (not shown), an operation valve 13 configured to control a bucket cylinder (not shown), an operation valve 14 for boom first gear configured to control a boom cylinder 31, and an operation valve 15 for arm second gear configured to control the arm cylinder (not shown) in order from the upstream side. The second traveling motor, the bucket cylinder, the boom cylinder 31, and the arm cylinder correspond to fluid pressure actuators (hereinafter, simply referred to as the “actuators”).

The operation valves 12 to 15 control flow rates of the working oil guided from the second main pump 27 to the actuators and control actions of the actuators. The operation valves 12 to 15 are operated by pilot pressure supplied in accordance with the operator of the hydraulic excavator manually operating the operation lever.

The operation valves 12 to 15 are connected to the second main pump 27 through a neutral passage 16. The operation valve 13 and the operation valve 14 are connected to the second main pump 27 through a parallel passage 17 parallel to the neutral passage 16. On the downstream side of the operation valve 15 in the neutral passage 16, a pilot pressure generation mechanism 18 for generating the pilot pressure is provided. The pilot pressure generation mechanism 18 has the same function as the pilot pressure generation mechanism 8 on the side of the first main pump 26.

A pilot passage 19 is connected to the pilot pressure generation mechanism 18. The pilot pressure generated in the pilot pressure generation mechanism 18 is guided to the pilot passage 19. The pilot passage 19 is connected to a regulator 20 configured to control a discharge capacity (tilting angle of the swash plate) of the second main pump 27.

The regulator 20 controls the tilting angle of the swash plate of the second main pump 27 in proportion to the pilot pressure of the pilot passage 19 (a proportional constant takes a negative number). Thereby, the regulator 20 controls a pushing amount per one rotation of the second main pump 27. Therefore, when the operation valves 12 to 15 are switched to full stroke, a flow of the neutral passage 16 is eliminated, and the pilot pressure of the pilot passage 19 becomes zero, which makes the tilting angle of the second main pump 27 maximized. At this time, the pushing amount per one rotation of the second main pump 27 is maximized.

A second pressure sensor 21 configured to detect the pressure of the pilot passage 19 is provided in the pilot passage 19. A pressure signal detected by the second pressure sensor 21 is outputted to the controller 50 to be described later.

On the downstream of the first and second main pumps 26 and 27 in the neutral passages 6 and 16, a first main relief valve 62 configured to relieve pressure of the working oil when the pressure exceeds preliminarily set predetermined main relief pressure, a second main relief valve 63 whose relief pressure is set to be lower than the first main relief valve 62, and a switching valve 64 capable of connecting the neutral passages 6 and 16 to the second main relief valve 63 are provided. The predetermined main relief pressure is set to be so high that the lowest working pressure of the actuators can be sufficiently ensured.

The first main relief valve 62 always communicates with the neutral passages 6 and 16. The second main relief valve 63 communicates with the neutral passages 6 and 16 in a case where the switching valve 64 is switched to an opened state. Thereby, when the switching valve 64 is switched to an opened state, the relief pressure of the neutral passages 6 and 16 is lowered in comparison to a case of a closed state.

A switching valve 61 serving as a switching valve for straight traveling is provided in a distribution passage 60 branching from the neutral passage 16. When the operation valve 5 configured to control the action of the first traveling motor and the operation valve 12 configured to control the action of the second traveling motor are switched to positions to move in the same direction, pressure of a pilot passage 65 is boosted. At the same time, when at least one of the operation valves 1 to 4 and 13 to 15 is switched to activate the actuator, pressure of a pilot passage 66 is boosted. Thereby, the switching valve 61 is switched to an opened state by the pilot pressure.

When the switching valve 61 is switched to an opened state, the working oil discharged from the second main pump 27 is supplied to the first traveling motor and the second traveling motor via the operation valve 5 and the operation valve 12 at the same flow rate. Thereby, in the hydraulic excavator, even when the operator intends to let the hydraulic excavator travel straight on but other actuators are actuated, the first traveling motor and the second traveling motor are rotated at the same speed without receiving any influence of said other actuators. Therefore, the hydraulic excavator can travel straight on.

A power generator 22 configured to generate electric power by utilizing remaining power of the engine 28 is provided in the engine 28. The electric power generated in the power generator 22 is charged in a battery 24 via a battery charger 23. The battery charger 23 can charge the electric power in the battery 24 even in a case where the battery charger is connected to a normal household power source 25.

In the battery 24, a temperature sensor (not shown) serving as a temperature detector configured to detect a temperature of the battery 24, a voltage sensor (not shown) serving as a voltage detector configured to detect voltage of the battery 24, and a SOC calculation unit (not shown) configured to calculate a SOC (State of Charge) from the detected temperature and the detected voltage are provided. The temperature sensor, the voltage sensor, and the SOC calculation unit output electric signals in accordance with the detected values to the controller 50 to be described later.

It should be noted that instead of the configuration in which the temperature sensor, the voltage sensor, and the SOC calculation unit are provided in the battery 24, for example, the temperature sensor and the voltage sensor may be attached to an external part of the battery 24, and the SOC calculation unit may be provided in the controller 50.

Next, the boom cylinder 31 will be described.

The operation valve 14 configured to control the action of the boom cylinder 31 is a three-position switching valve. The operation valve 14 is operated by the pilot pressure supplied from a pilot pump 29 to pilot chambers 14b and 14c through a pilot valve 56 in accordance with the operator of the hydraulic excavator manually operating an operation lever 55. The operation valve 3 for boom second gear is switched in conjunction with the operation valve 14 in a case where an operation amount of the operation lever 55 by the operator is more than a predetermined amount.

In a case where the pilot pressure is supplied to the pilot chamber 14b, the operation valve 14 is switched to an extended position (right side position in FIG. 1). When the operation valve 14 is switched to the extended position, the working oil discharged from the second main pump 27 is supplied to a piston side chamber 31a of the boom cylinder 31 through a supply and discharge passage 30, and the return working oil from a rod side chamber 31b is discharged to the tank through a supply and discharge passage 33. Therefore, the boom cylinder 31 is extended and a boom is lifted.

Meanwhile, in a case where the pilot pressure is supplied to the pilot chamber 14c, the operation valve 14 is switched to a stowed position (left side position in FIG. 1). When the operation valve 14 is switched to the stowed position, the working oil discharged from the second main pump 27 is supplied to the rod side chamber 31b of the boom cylinder 31 through the supply and discharge passage 33, and the return working oil from the piston side chamber 31a is discharged to the tank through the supply and discharge passage 30. Therefore, the boom cylinder 31 is stowed and the boom is lowered.

In a case where the pilot pressure is not supplied to both the pilot chambers 14b and 14c, the operation valve 14 is switched to a neutral position (state shown in FIG. 1). When the operation valve 14 is switched to the neutral position, supply and discharge of the working oil to and from the boom cylinder 31 are blocked, and the boom is maintained in a stopped state.

In a case where the operation valve 14 is switched to the neutral position and movement of the boom is stopped, force in the stowing direction acts on the boom cylinder 31 by self-weight of a bucket, an arm, the boom, and the like. In such a way, the boom cylinder 31 maintains a load by the piston side chamber 31a in a case where the operation valve 14 is placed at the neutral position. Therefore, the piston side chamber 31a corresponds to a load side pressure chamber.

The control system 100 of the hybrid construction machine includes a regeneration unit 45 configured to collect energy of the working oil from the boom cylinder 31 and perform energy regeneration. Hereinafter, the regeneration unit 45 will be described.

The regeneration unit 45 has a regeneration motor 46 for regeneration to be rotated by the working oil discharged from the piston side chamber 31a of the boom cylinder 31, an electric motor 48 serving as a rotating electric motor/power generator coupled to the regeneration motor 46, an inverter 49 configured to convert electric power generated by the electric motor 48 into a direct current, and the battery 24 serving as the storage battery configured to store the electric power generated by the electric motor 48.

Regeneration control by the regeneration unit 45 is executed by the controller 50. The controller 50 includes a CPU (central processing unit) configured to execute the regeneration control, a ROM (read only memory) in which a control program, setting values, and the like required for processing actions of the CPU are stored, and a RAM (random access memory) configured to temporarily store information detected by various sensors.

The regeneration motor 46 is a variable capacity type motor in which a tilting angle can be adjusted, the motor being coupled to be rotated coaxially to the electric motor 48. The regeneration motor 46 can drive the electric motor 48. In a case where the electric motor 48 functions as a power generator, the electric power generated by the electric motor 48 is charged in the battery 24 via the inverter 49. The regeneration motor 46 and the electric motor 48 may be directly coupled or may be coupled via a reducer.

On the upstream of the regeneration motor 46, a pump-up passage 51 is connected, through which the working oil is pumped up from the tank to a regeneration passage 52 to be described later and supplied to the regeneration motor 46 in a case where an amount of supplying the working oil to the regeneration motor 46 becomes insufficient. In the pump-up passage 51, a check valve 51a configured to allow only a flow of the working oil from the tank to the regeneration passage 52 is provided.

In the supply and discharge passage 30 connecting the piston side chamber 31a of the boom cylinder 31 and the operation valve 14, an electromagnetic proportional throttle valve 34 serving as a variable throttle whose opening degree is controlled by an output signal of the controller 50 is provided. The electromagnetic proportional throttle valve 34 is maintained at a full open position in a normal state.

The electromagnetic proportional throttle valve 34 bleeds a portion of the working oil to the tank via the operation valve 14, the portion being obtained by excluding a flow rate of the working oil guided to the regeneration motor 46 from the working oil discharged from the piston side chamber 31a of the boom cylinder 31. The electromagnetic proportional throttle valve 34 adjusts a bleed flow rate in such a manner that the working oil guided to the regeneration motor 46 does not exceed a regeneration ability of the regeneration unit 45. Adjustment of the bleed flow rate by the electromagnetic proportional throttle valve 34 will be described in detail later.

The regeneration passage 52 branching from a part between the piston side chamber 31a and the electromagnetic proportional throttle valve 34 is connected to the supply and discharge passage 30. The regeneration passage 52 is a passage for guiding the return working oil from the piston side chamber 31a to the regeneration motor 46.

In the regeneration passage 52, a switching valve 53 serving as a switching valve for regeneration to be controlled and switched by a signal outputted from the controller 50 is provided.

When a solenoid is not excited, the switching valve 53 is switched to a closed position (state shown in FIG. 1) to block the regeneration passage 52. When the solenoid is excited, the switching valve 53 is switched to an opened position to let the regeneration passage 52 communicate. The switching valve 53 blocks the working oil guided from the piston side chamber 31a to the regeneration motor 46 at the time of failure of the regeneration unit 45. Therefore, at the time of failure of the regeneration unit 45, since the working oil is not guided to the regeneration unit 45, the hybrid construction machine can be activated as a normal hydraulic excavator.

In the operation valve 14, a sensor 14a configured to detect the operating direction and an operation amount of the operation valve 14 is provided. A signal of pressure detected by the sensor 14a is outputted to the controller 50. Detection of the operating direction and the operation amount of the operation valve 14 is equal to detection of the extending/stowing direction and extending/stowing speed of the boom cylinder 31. Therefore, the sensor 14a functions as an action state detector configured to detect an action state of the boom cylinder 31. The sensor 14a may be a pressure sensor configured to detect the pressure of the pilot chambers 14b and 14c.

It should be noted that instead of the sensor 14a, a sensor configured to detect the moving direction and a moving amount of a piston rod may be provided in the boom cylinder 31 as an action state detector. Alternatively, a sensor configured to detect the operating direction and an operation amount of the operation lever 55 may be provided in the operation lever 55.

The controller 50 judges whether the operator intends to extend or stow the boom cylinder 31 on the basis of a detection result of the sensor 14a. When the controller 50 judges an extending action of the boom cylinder 31, the controller maintains the electromagnetic proportional throttle valve 34 at a full open position in a normal state and maintains the switching valve 53 at a closed position.

Meanwhile, when the controller 50 judges a stowing action of the boom cylinder 31, the controller calculates the stowing speed of the boom cylinder 31 demanded by the operator in accordance with the operation amount of the operation valve 14, decreases the opening degree of the electromagnetic proportional throttle valve 34, and switches the switching valve 53 to an opened position. Thereby, part or all of the return working oil from the boom cylinder 31 is guided to the regeneration motor 46, and boom regeneration is performed.

Next, an assist pump 47 configured to assist outputs of the first and second main pumps 26 and 27 will be described.

The assist pump 47 is a variable capacity type pump in which a tilting angle can be adjusted, the pump being coupled to be rotated coaxially to the regeneration motor 46. The assist pump 47 is rotated by regeneration drive force of the regeneration unit 45 and drive force of the electric motor 48. The rotation number of the electric motor 48 is controlled by the controller 50 through the inverter 49. The tilting angles of the swash plates of the assist pump 47 and the regeneration motor 46 are controlled by the controller 50 via regulators 35 and 36.

A discharge passage 37 serving as an assist passage is connected to the assist pump 47. The assist pump 47 can supply the working oil to the neutral passages 6 and 16 via the discharge passage 37. The discharge passage 37 is formed to be divided into a first assist passage 38 joining the discharge side of the first main pump 26 and a second assist passage 39 joining the discharge side of the second main pump 27.

First and second electromagnetic proportional throttle valves 40 and 41 whose opening degrees are controlled by output signals from the controller 50 are respectively provided in the first and second assist passages 38 and 39. Check valves 42 and 43 configured to allow only flows of the working oil from the assist pump 47 to the first and second main pumps 26 and 27 are respectively provided in the first and second assist passages 38 and 39 on the downstream of the first and second electromagnetic proportional throttle valves 40 and 41.

When the assist pump 47 is rotated by the drive force of the electric motor 48, the assist pump 47 assists the first and second main pumps 26 and 27. The controller 50 controls the opening degrees of the first and second electromagnetic proportional throttle valves 40 and 41 in accordance with the pressure signals from the first and second pressure sensors 11 and 21, and proportionally divides and supplies the working oil discharged from the assist pump 47 to the discharge side of the first and second main pumps 26 and 27.

When the working oil is supplied to the regeneration motor 46 through the regeneration passage 52, rotation force of the regeneration motor 46 acts as assist force to the coaxially rotating electric motor 48. Therefore, for the amount of the rotation force of the regeneration motor 46, electric power consumption of the electric motor 48 can be reduced.

In a case where the regeneration motor 46 drives the electric motor 48 and the electric power is generated, the tilting angle of the assist pump 47 is set to be zero and the assist pump is brought into a substantially no load state.

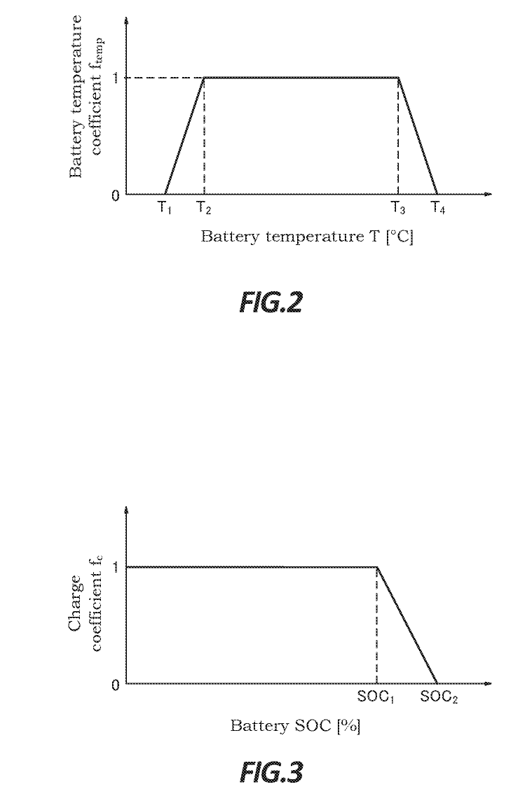

Next, mainly with reference to FIGS. 2 and 3, the regeneration control in the control system 100 of the hybrid construction machine will be described.

In a map shown in FIG. 2, the horizontal axis indicates a temperature T[° C.] of the battery 24, and the vertical axis indicates a battery temperature coefficient fₜₑₘₚ. The battery temperature coefficient fₜₑₘₚ is a coefficient whose maximum value is set to be one.

Regarding the battery 24, in a case where the temperature is lower and higher than a proper temperature range, a charge performance is lowered. A range from not less than T₂[° C.] and not more than T₃[° C.] is the proper temperature range. Therefore, in a case where the temperature T of the battery 24 is lower than T₂[° C.], the battery temperature coefficient fₜₑₘₚ is set to be smaller as the temperature is lowered toward T₁[° C.]. The battery temperature coefficient fₜₑₘₚ becomes zero when the temperature T of the battery 24 becomes T₁[° C.].

Similarly, in a case where the temperature T of the battery 24 is higher than T₃[° C.], the battery temperature coefficient fₜₑₘₚ is set to be smaller as the temperature is increased toward T₄[° C.]. The battery temperature coefficient fₜₑₘₚ becomes zero when the temperature T of the battery 24 becomes T₄[° C.].

Meanwhile, in a map shown in FIG. 3, the horizontal axis indicates the SOC[%] of the battery 24, and the vertical axis indicates a charge coefficient f_{c}. The charge coefficient f_{c} is a coefficient whose maximum value is set to be one.

Regarding the battery 24, in a case where the SOC is higher than a predetermined range, there is a need for lowering a charge amount in order to prevent overcharge. The maximum value of the SOC chargeable in the battery 24 is SOC₂[%]. Therefore, in a case where the SOC of the battery 24 is higher than SOC₁[%] set to be lower than SOC₂[%], the charge coefficient f_{c} is set to be smaller as the SOC is increased toward SOC₂[%]. The charge coefficient f_{c} becomes zero when the SOC of the battery 24 becomes SOC₂[%].

When the controller 50 judges that the boom cylinder 31 is performing the stowing action on the basis of the detection result of the sensor 14a, the controller switches the switching valve 53 to an opened position. Thereby, at the time of stowing the boom cylinder 31, the return working oil from the piston side chamber 31a is guided to the regeneration motor 46, and the regeneration control of the boom regeneration is started.

Firstly, an electric signal in accordance with the temperature of the battery 24 and an electric signal in accordance with the SOC of the battery 24 are inputted to the controller 50 from the battery 24. The controller 50 obtains the battery temperature coefficient fₜₑₘₚ corresponding to the temperature of the battery 24 from the map of FIG. 2, and obtains the charge coefficient f_{c} corresponding to the SOC of the battery 24 from the map of FIG. 3.

Regarding the working oil discharged from the piston side chamber 31a at the time of lowering the boom and stowing the boom cylinder 31, a flow rate Q_{c} among a flow rate Q is instructed to be a flow rate of the working oil to flow to the regeneration motor 46, and the remaining flow rate O_{b}, which is the flow rate (Q−Q_{c}) of the working oil is bled to the tank through the electromagnetic proportional throttle valve 34 and the operation valve 14.

At this time, the controller 50 instructs to calculate “flow rate Q_{c} of the working oil guidable to the regeneration motor 46 on the basis of a state of the battery 24”×“battery temperature coefficient fₜₑₘₚ”×“charge coefficient f_{c}”. The controller 50 also adjusts the opening degree of the electromagnetic proportional throttle valve 34 in such a manner that the working oil of “flow rate Q_{b}”+“flow rate Q_{c}”×(1−“battery temperature coefficient fₜₑₘₚ”×“charge coefficient f_{c}”) is bled.

In such a way, a regeneration amount of the regeneration unit 45 is set to be low in a case where the temperature of the battery 24 is higher or lower than a preliminarily regulated range, and also set to be low in a case where the SOC of the battery 24 is higher than a preliminarily regulated capacity. The controller 50 also adjusts the opening degree of the electromagnetic proportional throttle valve 34 in such a manner that in a case where the temperature of the battery 24 is higher or lower than the preliminarily regulated range, the bleed flow rate is increased for “flow rate Q_{c}”×(1−“battery temperature coefficient fₜₑₘₚ”×“charge coefficient f_{c}”), and in such a manner that in a case where the SOC of the battery 24 is higher than the preliminarily regulated capacity, the bleed flow rate is also increased for “flow rate Q_{c}”×(1−“battery temperature coefficient fₜₑₘₚ”×“charge coefficient f_{c}”).

Therefore, in a case where the temperature of the battery 24 is higher or lower than the preliminarily regulated range, the opening degree of the electromagnetic proportional throttle valve 34 is increased more than in a case where the temperature of the battery 24 is within the preliminarily regulated range, and the bleed flow rate is increased. In a case where the SOC of the battery 24 is higher than the preliminarily regulated capacity, the opening degree of the electromagnetic proportional throttle valve 34 is also increased more than in a case where the SOC of the battery 24 is within a preliminarily regulated capacity range, and the bleed flow rate is increased. Thus, by adjusting the opening degree of the electromagnetic proportional throttle valve 34, at the time of lowering the boom and stowing the boom cylinder 31, adjustment can be made in such a manner that the flow rate of the working oil discharged from the piston side chamber 31a and guided to the regeneration motor 46 does not exceed the regeneration ability of the regeneration unit 45.

By making adjustment in such a manner that the regeneration flow rate does not exceed the regeneration ability of the regeneration unit 45, the working oil is prevented from being excessively guided to the regeneration unit 45 and the battery 24 is prevented from being excessively charged. Therefore, even in a case where the regeneration flow rate is controlled and changed, by controlling the opening degree of the electromagnetic proportional throttle valve 34 and adjusting the bleed flow rate, a change in working speed of the boom cylinder 31 can be suppressed. Thereby, since lowering speed of the boom is not changed by the temperature and the SOC of the battery 24, a feeling of strangeness at the time of operation can be eliminated.

Conventionally, in order to prevent lowering of the lowering speed of the boom in a case where the regeneration flow rate is controlled and changed, the opening degree of the electromagnetic proportional throttle valve 34 is increased and the bleed flow rate is set to rather high. Meanwhile, since the opening degree of the electromagnetic proportional throttle valve 34 is adjusted in accordance with the regeneration ability of the regeneration unit 45 in the present embodiment, there is no need for, in order to prevent lowering of the lowering speed of the boom, preliminarily increasing the opening degree of the electromagnetic proportional throttle valve 34 and setting the bleed flow rate to rather high. Thus, an energy saving performance can be improved.

According to the above first embodiment, the following effects are exerted.

At the time of lowering the boom and stowing the boom cylinder 31, the portion of the working oil obtained by excluding the flow rate of the working oil guided to the regeneration motor 46 from the working oil discharged from the piston side chamber 31a is bled through the electromagnetic proportional throttle valve 34. Thus, by adjusting the opening degree of the electromagnetic proportional throttle valve 34, adjustment can be made in such a manner that the flow rate of the working oil discharged from the piston side chamber 31a and guided to the regeneration motor 46 does not exceed the regeneration ability of the regeneration unit 45. Therefore, the working oil is prevented from being excessively guided to the regeneration unit 45. Thus, even in a case where the regeneration flow rate is controlled and changed, the change in the working speed of the boom cylinder 31 can be suppressed.

### Second Embodiment

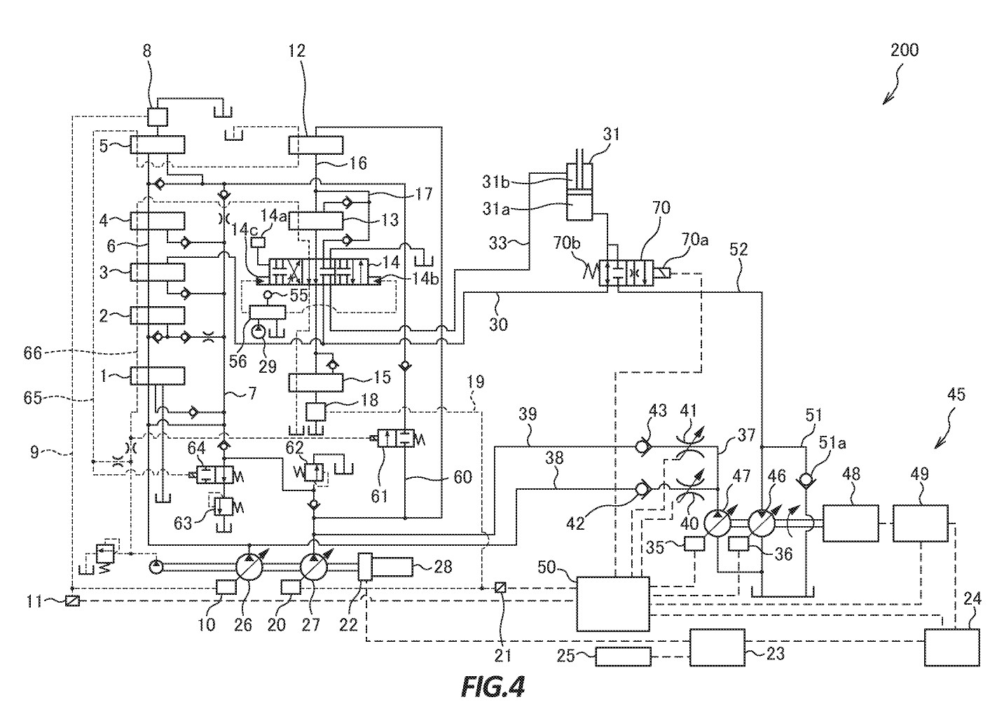

Hereinafter, with reference to FIG. 4, a control system 200 of a hybrid construction machine according to a second embodiment of the present invention will be described. Hereinafter, points different from the above embodiment will be mainly described, and configurations having the same functions will be given the same reference signs and description thereof will be omitted.

The control system 200 of the hybrid construction machine is different from the first embodiment in a point where the electromagnetic proportional throttle valve 34 and the switching valve 53 are provided as a single valve.

The control system 200 of the hybrid construction machine includes a boom regeneration valve 70 serving as a regeneration control valve configured to control a flow rate of working oil guided from a piston side chamber 31a to a regeneration motor 46 and a bleed flow rate of the bled working oil at the time of stowing a boom cylinder 31.

The boom regeneration valve 70 has functions as the electromagnetic proportional throttle valve 34 and the switching valve 53 in the first embodiment, and is switched by a single control signal from a controller 50. When a solenoid 70a is not excited, the boom regeneration valve 70 is switched by bias force of a return spring 70b in such a manner that all the working oil discharged from the piston side chamber 31a is bled (state shown in FIG. 4). This state corresponds to a state where the switching valve 53 is switched to a closed position and the opening degree of the electromagnetic proportional throttle valve 34 is adjusted to a maximum value in the first embodiment.

Meanwhile, when the solenoid 70a is excited, the boom regeneration valve 70 is switched in such a manner that part of the working oil discharged from the piston side chamber 31a is guided to the regeneration motor 46 and the bleed flow rate is decreased for the guided amount. This state corresponds to a state where the switching valve 53 is switched to an opened position and the opening degree of the electromagnetic proportional throttle valve 34 is adjusted to a small value in the first embodiment.

The boom regeneration valve 70 makes adjustment in such a manner that the more an excitation current is increased, the more the bleed flow rate is decreased. At this time, the bleed flow rate is changed in proportion to the excitation current (a proportional constant takes a negative number).

As well as the first embodiment, the controller 50 adjusts the excitation current of the solenoid 70a of the boom regeneration valve 70 in such a manner that in a case where a temperature of a battery 24 is higher or lower than a preliminarily regulated range, the bleed flow rate is increased, and in such a manner that in a case where a SOC of the battery 24 is higher than a preliminarily regulated capacity, the bleed flow rate is also increased. Since specific contents of regeneration control are the same as the first embodiment, description thereof will be omitted.

In the second embodiment described above, as well as the first embodiment, at the time of lowering a boom and stowing the boom cylinder 31, a portion of the working oil obtained by excluding the flow rate of the working oil guided to the regeneration motor 46 from the working oil discharged from the piston side chamber 31a is bled through the boom regeneration valve 70. Thus, by adjusting an opening degree of the boom regeneration valve 70, adjustment can be made in such a manner that the flow rate of the working oil discharged from the piston side chamber 31a and guided to the regeneration motor 46 does not exceed a regeneration ability of a regeneration unit 45. Therefore, the working oil is prevented from being excessively guided to the regeneration unit 45. Thus, even in a case where the regeneration flow rate is controlled and changed, a change in working speed of the boom cylinder 31 can be suppressed by adjusting the opening degree of the boom regeneration valve 70.

The boom regeneration valve 70 has the functions as the electromagnetic proportional throttle valve 34 and the switching valve 53, and is switched by a single control signal from the controller 50. Therefore, in comparison to a case where the electromagnetic proportional throttle valve 34 and the switching valve 53 are switched by separate control signals, the regeneration control can be more easily executed.

Configurations, operations, and effects of the embodiments of the present invention will be summarized below.

The control system 100, 200 of the hybrid construction machine is characterized by including the first and second main pumps 26 and 27 configured to supply the working oil to the boom cylinder 31, the regeneration unit 45 having the regeneration motor 46 for regeneration to be rotated by the working oil discharged from the piston side chamber 31a of the boom cylinder 31, the electric motor 48 coupled to the regeneration motor 46, and the battery 24 configured to store the electric power generated by the electric motor 48, and the electromagnetic proportional throttle valve 34 (boom regeneration valve 70) configured to bleed the portion of the working oil obtained by excluding the flow rate of the working oil guided to the regeneration motor 46 from the working oil discharged from the piston side chamber 31a.

With this configuration, the portion of the working oil obtained by excluding the flow rate of the working oil guided to the regeneration motor 46 from the working oil discharged from the piston side chamber 31a of the boom cylinder 31 is bled through the electromagnetic proportional throttle valve 34 (boom regeneration valve 70). Therefore, by adjusting the opening degree of the electromagnetic proportional throttle valve 34 (boom regeneration valve 70), the bleed flow rate of the working oil obtained by excluding the flow rate of the working oil guided to the regeneration motor 46 from the flow rate of the working oil discharged from the piston side chamber 31a can be adjusted. Thus, even in a case where the regeneration flow rate is controlled and changed, the change in the working speed of the boom cylinder 31 can be suppressed.

The control system is characterized in that the electromagnetic proportional throttle valve 34 (boom regeneration valve 70) adjusts the bleed flow rate in such a manner that the working oil guided to the regeneration motor 46 does not exceed the regeneration amount of the regeneration unit 45.

The control system is characterized in that the regeneration amount of the regeneration unit 45 is set to be low in a case where the temperature of the battery 24 is higher or lower than the preliminarily regulated range.

The control system is characterized in that the regeneration amount of the regeneration unit 45 is set to be low in a case where the SOC of the battery 24 is higher than the preliminarily regulated capacity.

With these configurations, the regeneration amount of the regeneration unit 45 is set on the basis of at least any one of the temperature of the battery 24 and the capacity of the SOC. The electromagnetic proportional throttle valve 34 (boom regeneration valve 70) adjusts the bleed flow rate in such a manner that the flow rate does not exceed the regeneration amount of the regeneration unit 45. Therefore, the working oil is prevented from being excessively guided to the regeneration unit 45. Thus, since the lowering speed of the boom is not changed by the temperature and the SOC of the battery 24, the feeling of strangeness at the time of operation can be eliminated.

The control system 100 of the hybrid construction machine is characterized by further including the switching valve 53 configured to block the working oil guided from the piston side chamber 31a to the regeneration motor 46 at the time of failure of the regeneration unit 45.

With this configuration, at the time of failure of the regeneration unit 45, since the working oil is not guided to the regeneration unit 45. Thus, the hybrid construction machine can be activated as a normal hydraulic excavator.

The control system 200 of the hybrid construction machine is characterized by further including the controller 50 configured to execute the regeneration control of the hydraulic excavator, in that the electromagnetic proportional throttle valve and the switching valve (boom regeneration valve 70) are switched by a single control signal from the controller 50.

With this configuration, by switching the boom regeneration valve 70 by a single control signal from the controller 50, in comparison to a case where the electromagnetic proportional throttle valve 34 and the switching valve 53 are switched by separate control signals, the regeneration control can be more easily executed.

Embodiments of the present invention were described above, but the above embodiments are merely examples of applications of the present invention, and the technical scope of the present invention is not limited to the specific constitutions of the above embodiments.

For example, in the above embodiments, various coefficients are determined by using the maps shown in FIGS. 2 and 3. However, the present invention is not limited to this but various coefficients may be determined by functions.

With respect to the above description, the contents of application No. 2014-246911, with a filing date of Dec. 5, 2014 in Japan, are incorporated herein by reference.

1. A control system of a hybrid construction machine, comprising:
a fluid pressure pump configured to supply a working fluid to a fluid pressure actuator;
a regeneration unit having a regeneration motor for regeneration to be rotated by the working fluid discharged from a load side pressure chamber of the fluid pressure actuator, a rotating electric motor coupled to the regeneration motor, and a storage battery configured to store electric power generated by the rotating electric motor; and
a variable throttle configured to bleed a portion of the working fluid obtained by excluding a flow rate of the working fluid guided to the regeneration motor from the working fluid discharged from the load side pressure chamber.

2. The control system of the hybrid construction machine according to claim 1, wherein
the variable throttle adjusts a bleed flow rate in such a manner that the working fluid guided to the regeneration motor does not exceed a regeneration amount of the regeneration unit.

3. The control system of the hybrid construction machine according to claim 2, wherein
in a case where a temperature of the storage battery is higher or lower than a preliminarily regulated range, the regeneration amount of the regeneration unit is set to be lower than in a case where the temperature of the storage battery is within the preliminarily regulated range.

4. The control system of the hybrid construction machine according to claim 2, wherein
in a case where a SOC of the storage battery is higher than a preliminarily regulated capacity, the regeneration amount of the regeneration unit is set to be lower than in a case where the SOC of the storage battery is within a preliminarily regulated capacity range.

5. The control system of the hybrid construction machine according to claim 3, wherein
in a case where a SOC of the storage battery is higher than a preliminarily regulated capacity, the regeneration amount of the regeneration unit is set to be lower than in a case where the SOC of the storage battery is within a preliminarily regulated capacity range.

6. The control system of the hybrid construction machine according to claim 1, further comprising:
a regeneration switching valve configured to block the working fluid guided from the load side pressure chamber to the regeneration motor at the time of failure of the regeneration unit.

7. The control system of the hybrid construction machine according to claim 6, further comprising:
a controller configured to execute regeneration control of the hybrid construction machine, wherein
the variable throttle and the regeneration switching valve are switched by a single control signal from the controller.
